(19) United States
(12) Patent Application Publication
(10) Pub. No.: US 2013/0218748 A1
(43) Pub. Date: Aug. 22, 2013

(54) METHOD AND APPARATUS FOR MEASURING AND MONITORING POST-SALES CONDITIONS WITHIN A NETWORK TRADING PLATFORM

(71) Applicants: Nathan Sacco, San Jose, CA (US); Avid Larizadeh, Palo Alto, CA (US); George Liang, San Francisco, CA (US); Jason Lee, San Ramon, CA (US)

(72) Inventors: Nathan Sacco, San Jose, CA (US); Avid Larizadeh, Palo Alto, CA (US); George Liang, San Francisco, CA (US); Jason Lee, San Ramon, CA (US)

(73) Assignee: eBay Inc., San Jose, CA (US)

(21) Appl. No.: 13/852,601

(22) Filed: Mar. 28, 2013

Related U.S. Application Data
(63) Continuation of application No. 10/877,727, filed on Jun. 24, 2004, now abandoned.
(60) Provisional application No. 60/483,402, filed on Jun. 26, 2003.

(51) Int. Cl. G06Q 40/04

(52) U.S. Cl. CPC G06Q 40/04
USPC 705/37

(57) ABSTRACT

A method and a system to measure and monitor post-sales conditions within a network-based trading platform including a post-sales management module automatically to monitor post-sales parameters pertaining to an inventory of sold items and an alert module automatically to generate an alert when at least one post-sales parameter transgresses a threshold.

### CROSS-REFERENCE TO RELATED APPLICATIONS

This patent application claims a priority benefit and is a continuation application of prior U.S. patent application Ser. No. 10/877,727, entitled “Method and Apparatus for Measuring and Monitoring Post-Sales Conditions Within a Network Trading Platform,” filed on Jun. 24, 2004, which claims a priority benefit of prior U.S. Provisional Patent Application No. 60/483,402, entitled “Method and Apparatus for Measuring and Monitoring Post-Sales Conditions Within a Network Trading Platform,” filed on Jun. 26, 2003, which are hereby incorporated by reference in their entirety.

### FIELD OF THE INVENTION

Exemplary embodiments of the present invention relate generally to the technical field of commerce automation and, in one exemplary embodiment, to methods and systems to measure and monitor post-sales conditions within a network-based trading platform.

### BACKGROUND OF THE INVENTION

Network-based marketplaces have become increasingly popular venues for the buying and selling of goods and services as communication speeds and processing power have enabled the adoption of the Internet in everyday society. As such, new generations of sellers have become empowered with a medium on which to sell their goods and services (e.g., home based businesses that sell their goods through the Internet). As many of these sellers expand their business, there is increasing complexity in the administration and management of their transactions over network-based marketplaces (e.g., knowing which transactions are still pending resolution, which buyers have paid, which items need to be shipped, how much profit/loss, etc.)

Technology to aid sellers with their transaction processes has largely been limited to manual offline accounting (e.g., spreadsheets, databases, etc.), and disparate buyer based reporting systems (e.g., online transaction history summaries for a particular buyer). Manual offline accounting systems may require that sellers input data twice, and constantly devote time and resources to updating databases and spreadsheets offline from individual network-based trading systems.

Similarly, disparate buyer based reporting systems are inefficient because sellers can only see limited transaction details for a buyer, and different systems (e.g., different network-based trading systems) must be used to administer reporting systems on different networks. Unfortunately, smaller sellers are often unable to keep up with the demand on their limited time to maintain such offline systems (e.g., investment required exceeds budget), and service levels within a network-based trading system suffer (products do not get shipped, fraudulent buyers are disguised, etc.).

In order to make a network-based trading environment more meaningful for sellers, there is some incentive for operators to provide systems for managing inventory across multiple network-based trading systems and for managing post-sales conditions in a unified view. However, the design of such integrated systems present a number of technical challenges, specifically regarding how databases are organized and how metrics are generated for a plurality of network-based trading systems. Further, a number of technical challenges exist with respect to the automation of post-sales conditions because these conditions are in constant flux and a number of variables that must be concurrently resolved in order to keep databases up to date and to manage space within a data mart is quite large.

### SUMMARY OF THE INVENTION

A method and a system to measure and monitor post-sales conditions within a network-based trading platform including a post-sales management module automatically to monitor post-sales parameters pertaining to an inventory of sold items and an alert module automatically to generate an alert when at least one post-sales parameter transgresses a threshold.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a commerce system, according to one exemplary embodiment.

FIG. 2 is a block diagram illustrating multiple market applications provided as part of a network-based marketplace and payment applications, according to one exemplary embodiment.

FIG. 3 is a high-level entity relationship diagram, illustrating various tables that may be leveraged by a network-based trading system including a collection of tables inside a post-sales management module, according to one exemplary embodiment.

FIG. 4 shows various fields within tables inside the post-sales management module, according to one exemplary embodiment.

FIG. 5 shows a functional view of the post-sales management module, according to one exemplary embodiment.

FIG. 6 is a relational view between the synchronization module, the inventory module, and the accounting module inside the post-sales management module, according to one exemplary embodiment.

FIG. 7 is an exploded view of the alert and notify module within the post-sales management module, according to one exemplary embodiment.

FIG. 8 is a process flow of operations within the synchronization module, according to one exemplary embodiment.

FIG. 9 is a seller client, server, and buyer client interaction diagram showing communications between the server and clients, according to one exemplary embodiment.

FIG. 10 is a process flow of operations within the accounting module, according to one exemplary embodiment.

FIG. 11 shows a diagrammatic representation of machine in the exemplary form of a computer system, according to one exemplary embodiment.

FIGS. 12-16 illustrate exemplary user interfaces (UIs) presented to a user of the network-based trading system, according to various exemplary embodiments.

### DETAILED DESCRIPTION

A method and system to measure and monitor post-sales conditions within a network-based trading platform are described. In the following description, for purposes of explanation, numerous specific details are set forth in order to provide a thorough understanding of the present invention. It will be evident, however, to one skilled in the art that the present invention may be practiced without these specific details.

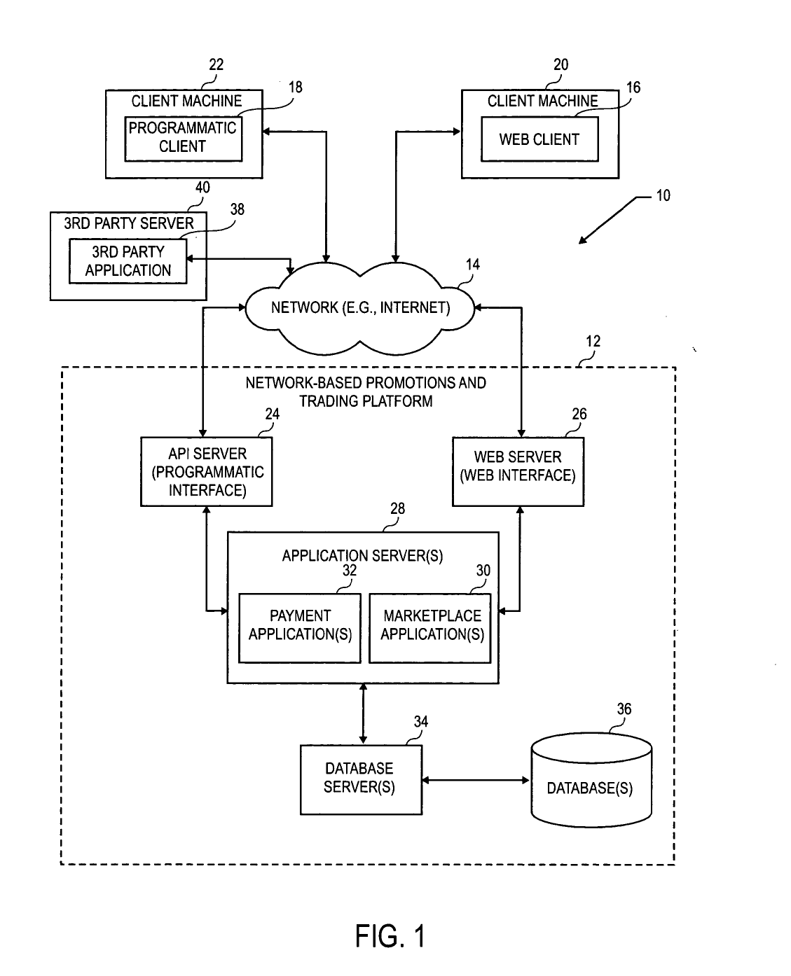

FIG. 1 is a network diagram depicting a System 10, according to one exemplary embodiment, having a client-server architecture. A commerce platform, in the exemplary form of a Network-Based Marketplace 12, provides server-side functionality, via a Network 14 (e.g., the Internet) to one or more clients. FIG. 1 illustrates, for example, a Web Client 16 (e.g., a browser, such as the INTERNET EXPLORER browser developed by Microsoft Corporation of Redmond, Wash. State), and a Programmatic Client 18 executing on respective Client Machines 20 and 22.

Turning specifically to the Network-Based Marketplace 12, an Application Program Interface (API) Server 24 and a Web Server 26 are coupled to, and provide programmatic and web interfaces respectively to, one or more Application Servers 28. The Application Servers 28 host one or more Marketplace Applications 30 and Payment Applications 32. The Application Servers 28 are, in turn, shown to be coupled to one or more Databases Servers 34 that facilitate access to one or more Databases 36.

The Marketplace Applications 30 provide a number of marketplace functions and services to users that access the Marketplace 12 (e.g., post-sales management functions). The Payment Applications 32 likewise provide a number of payment services and functions to users. The Payment Applications 32 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the Marketplace Applications 30. While the Marketplace and Payment Applications 30 and 32 are shown in FIG. 1 to both form part of the Network-Based Marketplace 12, it will be appreciated that, in alternative embodiments, the Payment Applications 32 may form part of a payment service that is separate and distinct from the Marketplace 12.

Further, while the System 10 shown in FIG. 1 employs a client-server architecture, the present invention is of course not limited to such an architecture, and could equally well find application in a distributed, or peer-to-peer, architecture system. The various Marketplace and Payment Applications 30 and 32 could also be implemented as standalone software programs, which do not necessarily have networking capabilities.

The Web Client 16, it will be appreciated, accesses the various Marketplace and Payment Applications 30 and 32 via the web interface supported by the Web Server 26. Similarly, the Programmatic Client 18 accesses the various services and functions provided by the Marketplace and Payment Applications 30 and 32 via the programmatic interface provided by the API Server 24. The Programmatic Client 18 may, for example, be a seller application (e.g., the Turbo Lister application developed by eBay Inc., of San Jose, Calif.) to enable sellers to author and manage listings on the Marketplace 12 in an off-line manner, and to perform batch-mode communications between the Programmatic Client 18 and the Network-Based Marketplace 12.

FIG. 1 also illustrates a Third Party Application 38, executing on a Third Party Server Machine 40, as having programmatic access to the Network-Based Marketplace 12 via the programmatic interface provided by the API Server 24. For example, the Third Party Application 38 may, utilizing information retrieved from the Network-Based Marketplace 12, support one or more features or functions on a website hosted by the third party. The third party website may, for example, provide one or more promotional, marketplace or payment functions that are supported by the relevant applications of the Network-Based Marketplace 12.

### Marketplace Applications

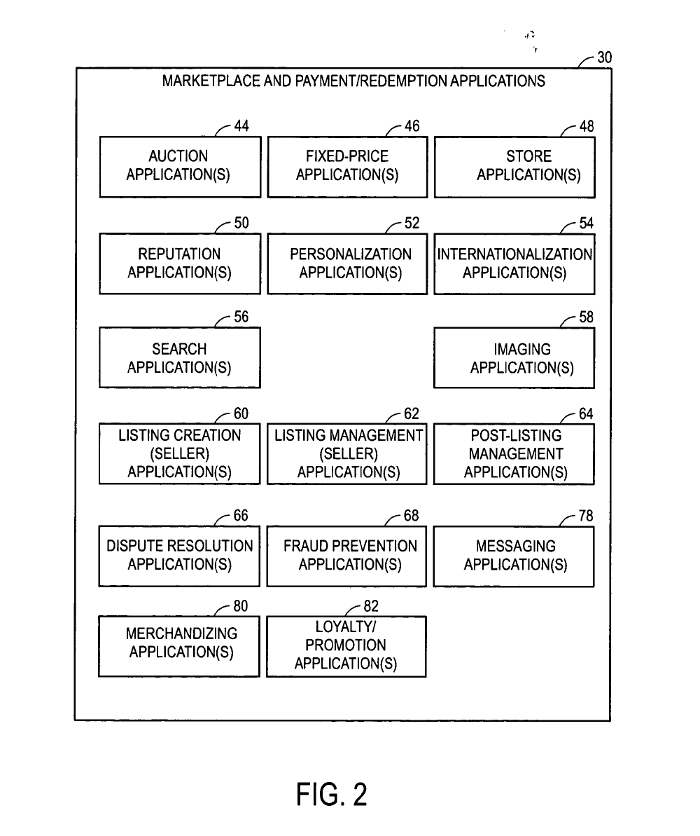

FIG. 2 is a block diagram illustrating multiple Marketplace 30 and Payment Applications 32 that, in one exemplary embodiment, are provided as part of the Network-Based Marketplace 12. The Marketplace 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the Marketplace Applications 30 are shown to include one or more Auction Applications 44 which support auction-format listing and price setting mechanisms (e.g., English, Dutch, Vickrey, Chinese, Double, Reverse auctions etc.). The various Auction Applications 44 may also provide a number of features in support of such auction-format listings, such as a reserve price feature whereby a seller may specify a reserve price in connection with a listing and a proxy-bidding feature whereby a bidder may invoke automated proxy bidding.

A number of Fixed-Price Applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store Applications 48 allow sellers to group their listings within a “virtual” store, which may be branded and otherwise personalized by and for the sellers. Such a virtual store may also offer promotions, incentives and features that are specific and personalized to a relevant seller.

Reputation Applications 50 allow parties that transact utilizing the Network-Based Marketplace 12 to establish build and maintain reputations, which may be made available and published to potential trading partners. Consider that where, for example, the Network-Based Marketplace 12 supports person-to-person trading, users may have no history or other reference information whereby the trustworthiness and credibility of potential trading partners may be assessed. The Reputation Applications 50 allow a user, for example through feedback provided by other transaction partners, to establish a reputation within the Network-Based Marketplace 12 over time. Other potential trading partners may then reference such a reputation for the purposes of assessing credibility and trustworthiness.

Personalization Applications 52 allow users of the Marketplace 12 to personalize various aspects of their interactions with the Marketplace 12. For example a user may, utilizing an appropriate Personalization Application 52, create a personalized reference page at which information regarding transactions to which the user is (or has been) a party may be viewed. Further, a Personalization Application 52 may enable a user to personalize listings and other aspects of their interactions with the Marketplace 12 and other parties.

In one embodiment, the Network-Based Marketplace 12 may support a number of marketplaces that are customized, for example, for specific geographic regions. A version of the Marketplace 12 may be customized for the United Kingdom, whereas another version of the Marketplace 12 may be customized for the United States. Each of these versions may operate as an independent marketplace, or may be customized (or internationalized) presentations of a common underlying marketplace.

Navigation of the Network-Based-Marketplace 12 may be facilitated by one or more Navigation Applications 56. For example, a search application enables key word searches of listings published via the Marketplace 12. A browse application allows users to browse various category, catalogue, or inventory data structures according to which listings may be classified within the Marketplace 12. Various other navigation applications may be provided to supplement the search and browsing applications.

In order to make listings, available via the network-based Marketplace 12, as visually informing and attractive as possible, the Marketplace Applications 30 may include one or more Imaging Applications 58 utilizing which users may upload images for inclusion within listings. An Imaging Application 58 also operates to incorporate images within viewed listings. The Imaging Applications 58 may also support one or more promotional features, such as image galleries that are presented to potential buyers. For example, sellers may pay an additional fee to have an image included within a gallery of images for promoted items.

Listing Creation Applications 60 allow sellers conveniently to author listings pertaining to goods or services that they wish to transact via the Marketplace 12, and Listing Management Applications 62 allow sellers to manage such listings. Specifically, where a particular seller has authored and/or published a large number of listings, the management of such listings may present a challenge.

The Listing Management Applications 62 provide a number of features (e.g., auto-relisting, inventory level monitors, etc.) to assist the seller in managing such listings. In one embodiment, the Listing Creating Applications 60 may include a pre-sales management logic (not shown) having a set of one or more templates (e.g., reusable pre-arrangements of data that can be applied to future listings). These templates may be created by a seller from scratch, or may be created from existing listings. In one embodiment, templates may include all information included in a preexisting listing. In another embodiment, information in a first listing may be selected by a user and reused for future listings (e.g., a user may not have to elect to use all portions of a listing to include within a template). A user may alternatively select multiple products to leverage the same template when listing items for sale (e.g., a seller might use a standard template for a group of products or services with similar attributes). Furthermore, the templates may be grouped into products having their own set of auction parameters (e.g., specific to the laws and customs of a particular nation, stock keeping unit parameters, categories, durational limitations, etc.) The categories may include geographical (e.g., which country something is to be sold in) and time phased markers (e.g., time limits for listing and/or a unique marker within the listing) according to one embodiment.

One or more Post-Listing Management Applications 64 also assist sellers with a number of activities that typically occur post-listing. For example, upon completion of an auction facilitated by one or more Auction Applications 44, a seller may wish to leave feedback regarding a particular buyer. To this end, a Post-Listing Management Application 64 may provide an interface to one or more Reputation Applications 50, so as to allow the seller conveniently to provide feedback regarding multiple buyers to the Reputation Applications 50. In addition, a Post-Listing Management Application 64 may provide for measuring and monitoring post-sales conditions within a network-based trading module by interacting with the Auction Application 44 and the Store Application 48 according to one embodiment of the invention.

Dispute Resolution Applications 66 provide mechanisms whereby disputes arising between transacting parties may be resolved. For example, the dispute

Resolution Applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of Fraud Prevention Applications 68 implement various fraud detection and prevention mechanisms to reduce the occurrence of fraud within the Marketplace 12.

Messaging Applications 70 are responsible for the generation and delivery of messages to users of the Network-Based Marketplace 12, such messages for example advising users regarding the status of listings at the Marketplace 12 (e.g., providing “outbid” notices to bidders during an auction process or to provide promotional and merchandising information to users).

Merchandising Applications 72 support various merchandising functions that are made available to sellers to enable sellers to increase sales via the Marketplace 12. The Merchandising Applications 72 also operate the various merchandising features that may be invoked by sellers, and may monitor and track the success of merchandising strategies employed by sellers.

The Network-Based Marketplace 12 itself, or one or more parties that transact via the Marketplace 12, may operate loyalty programs that are supported by one or more Loyalty/Promotions Applications 74. For example, a buyer may earn loyalty or promotions points for each transaction established and/or concluded with a particular seller, and be offered a reward for which accumulated loyalty points can be redeemed.

### Data Structures

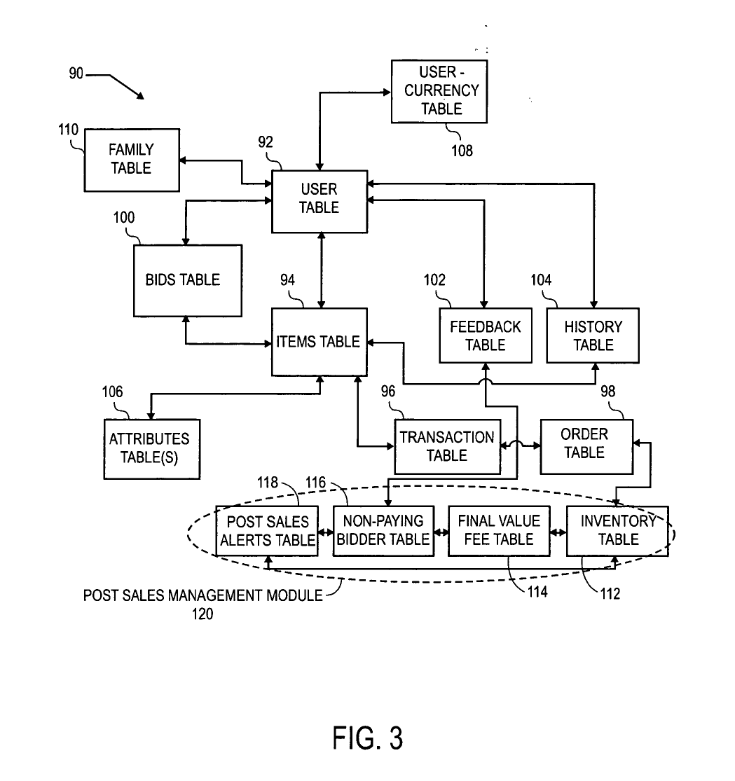

FIG. 3 is a high-level entity-relationship diagram, illustrating various Tables 90 that may be maintained within the Databases 36, and that are utilized by and support the Marketplace and Payment Applications 30 and 32. A User Table 92 includes a record for each registered user of the Network-Based Marketplace 12, and may include identifier, address and financial instrument information pertaining to each such registered user. A user may, it will be appreciated, operate as a seller, a buyer, or both, within the network-based Marketplace 12. In one exemplary embodiment, a buyer may be a user that has accumulated value (e.g., commercial or proprietary currency), and is then able to exchange the accumulated value for items that are offered for sale by the Network-Based Marketplace 12.

The Tables 90 also include an Items Table 94 in which are maintained item records for goods and services that are available to be, or have been, transacted via the Marketplace 12. Each item record within the Items Table 94 may furthermore be linked to one or more user records within the User Table 92, so as to associate a seller and one or more actual or potential buyers with each item record.

A Transaction Table 96 includes a record for each transaction (e.g., a purchase transaction) pertaining to items for which records exist within the Items Table 94.

An order Table 98 is populated with order records, each order record being associated with an order. Each order, in turn, may be with respect to one or more transactions for which records exist within the Transactions Table 96.

Bid records within a Bids Table 100 each relate to a bid received at the Network-Based Marketplace 12 in connection with an auction-format listing supported by an Auction Application 44. A Feedback Table 102 is utilized by one for more Reputation Applications 50, in one exemplary embodiment, to construct and maintain reputation information concerning users. A History Table 104 maintains a history of transactions to which a user has been a party. One or more Attributes Tables 106 record attribute information pertaining to items for which records exist within the Items Table 94. Considering only a single example of such an attribute, the Attributes Tables 106 may indicate a currency attribute associated with a particular item, the currency attribute identifying the currency of a price for the relevant item as specified in by a seller.

A Post-Sales Management Module 120 may also interact with the Order Table 98. The Post-Sales Management Module 120 is illustrated as including an Inventory Table 112, a Final Value Fee Table 114, a Non-Paying Bidder Table 116, and a Post-Sales Alerts Table 118. The Inventory Table 112 may include information about current inventory (e.g., quantity, description, location, etc.) for a particular seller across one or more network-based trading platforms according to one embodiment. The Inventory Table 112 may adjust its inventory depending on the status of inventory (e.g., sold, shipped, return) in the Order Table 98 and the Transaction Table 96. The Final Value Fee Table 114 is populated with fees (e.g., per listing trading fees) to be paid to a Network-Based Marketplace 12 by sellers transacting business through the network-based Marketplace 12 in one embodiment. The Final Value Fee Table 114 interacts with the Inventory Table 112 by requesting and calculating trading fees for each item of inventory that has been sold. The Non-Paying Bidder Table 116 also interacts with the Final Value Fee Table 114 and the Feedback Table 102 by storing information about particular buyers who have not paid fees owed to sellers and/or the network-based marketplace 12 in another embodiment. The Post-Sales Alerts Table 118 interacts with the Inventory Table 112 and the Non-Paying Bidder Table 116 and is populated with alerts that are to be displayed to sellers and buyers through the Network-Based Marketplace 12.

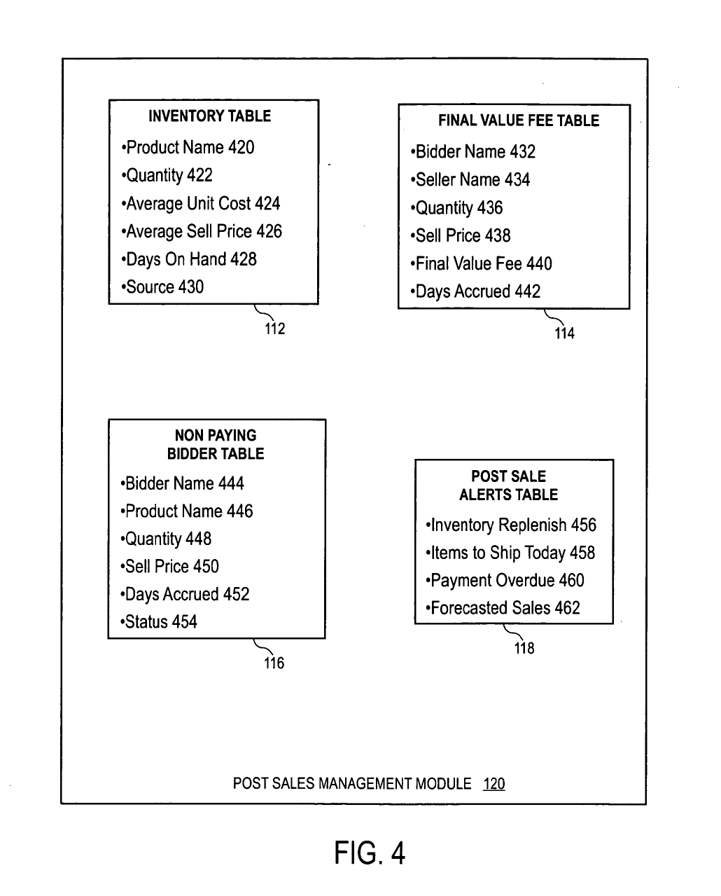

FIG. 4 shows various fields within tables inside the Post-Sales Management Module 120, according to one exemplary embodiment. Illustrated in FIG. 4 are an Inventory Table 112, a Final Value Fee Table 114, a Non Paying Bidder Table 116, and a Post-sales Alerts Table 118. It should be noted that the exemplary tables and exemplary fields within each table as shown in FIG. 4 are intended to merely be illustrative, and not limiting. Numerous other permutations and fields are possible within each of the tables shown in FIG. 4, but which have not been specifically disclosed herein.

The Inventory Table 112 illustrates an exemplary number of fields denoting inventory at a particular seller. These fields include Product Name 420, Quantity 422, Average Unit Cost 424, Average Sell Price 426, Days On Hand 428, and Source 430. In one embodiment, a user (e.g., a seller who wishes to keep track of inventory through a network-based trading system) can input inventory directly into the Inventory Table 112 through the Internet. In another embodiment, the Inventory Table 112 shown in FIG. 4 can be populated automatically through an upload from an external database (e.g., an enterprise resource planning system or a small-business management application).

The Final Value Fee Table 114 includes information about the calculation of fees for a particular transaction. The Final Value Fee Table 114 includes fields such as, but not limited to Bidder Name 432, Seller Name 434, Quantity 436, Sell Price 438, Final Value Fee 440, and Days Accrued 442. In one embodiment, the Final Value Fee Table 114 is used to calculate the amount a particular seller owes to a network-based trading platform for transaction-based fees (e.g., selling and listing fees). The Final Value Fee Table 114 may also be automatically populated through logic within the network-based trading platform that uses a formula to determine how much is owed to a seller based upon a particular dollar amount for a transaction.

The Non-Paying Bidder Table 116 includes information about bidders who have not yet paid a seller. In the exemplary embodiment shown in FIG. 4, inside the Non Paying Bidder Table 116 are fields that include Bidder Name 444, Product Name 446, Quantity 448, Sell Price 450, Days Accrued 452, and Status 454. The Non-Paying Bidder Table 116 may be used to keep track of how many days it has been since a buyer placed a successful bid (or entered into a fixed price contract), and how many days the buyer has taken to pay the network-based trading system in one embodiment. In another embodiment, the Non-Paying Bidder Table 116 may be used to schedule and prioritize alerts that are sent out to sellers. The Non-Paying Bidder Table 116 may also link to a resolution table (not shown) that might include a subset of the Non-Paying Bidder Table 116 for buyers and sellers who have elected to negotiate payment options.

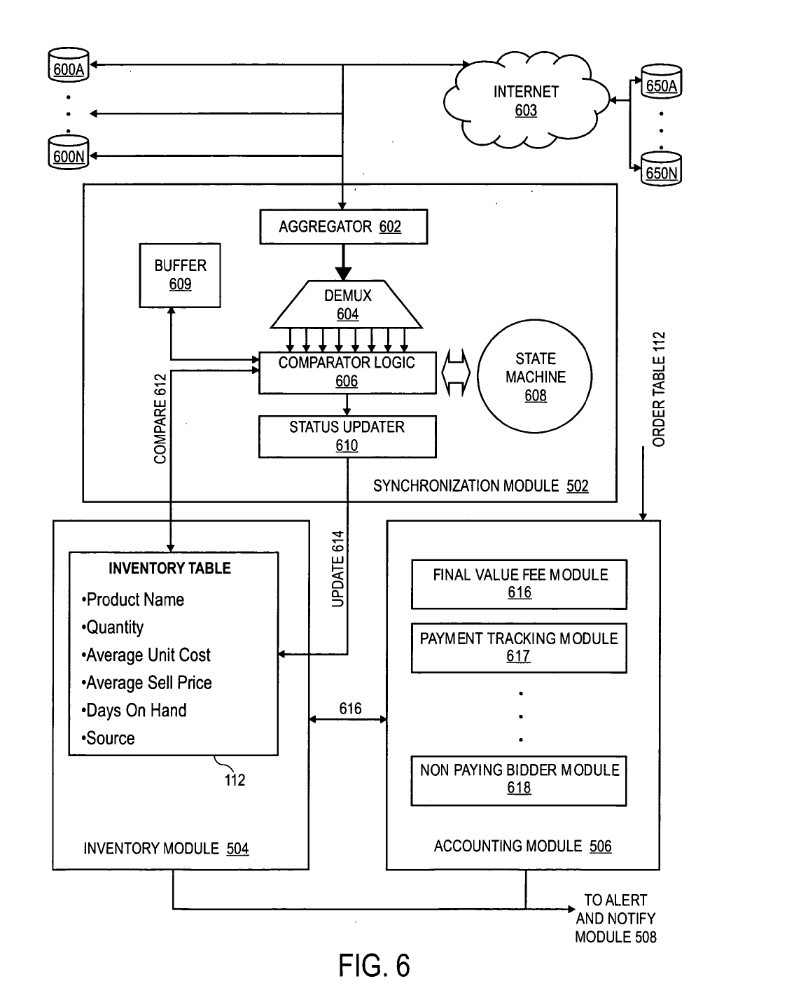

The Post-Sales Alerts Table 118 includes information that needs to be communicated to either sellers or buyers within a network-based trading platform. The Post-Sale Alerts Table 118 includes fields such as Inventory Replenish 456, Items to Ship Today 458, Payment Overdue 460, and Forecasted Sales 462. The Post-Sales Alerts Table 118 may pull data from other tables within the Post-Sales Management Module 120 or other tables as described with reference to FIG. 3. Furthermore, the Post-Sales Alerts Table 118 may be updated through a state machine (as later will be described with reference to FIG. 6 in State Machine 608) that pre-calculates values for input into the Post-Sales Alerts Table 118. The Post-Sales Alerts Table 118 may be communicated to a seller through an Internet-based dashboard or other communication means.

It should be stressed that the fields discussed with reference to FIG. 4 and illustrated in FIG. 4 are merely illustrative and are not intended to be limiting.

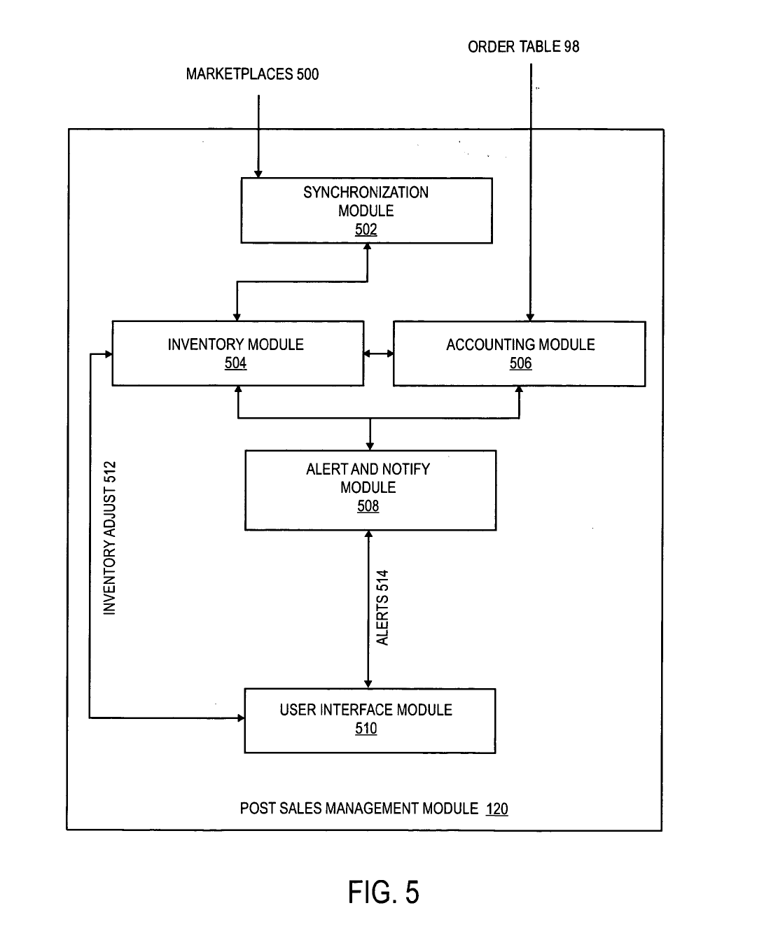

FIG. 5 shows a functional view of the Post-Sales Management Module 120 according to one embodiment. In FIG. 5 a Post-Sales Management Module 120 includes a Synchronization Module 502, an Inventory Module 504, an Accounting Module 506, an Alert and Notify Module 508, and a User Interface Module 510. Various Marketplaces 500 (e.g., private marketplaces, network-based marketplaces, Internet marketplaces, physical stores, etc.) send information to Synchronization Module 502 as later will be discussed to reference FIG. 6.

In one embodiment, the Synchronization Module 502 aggregates and compares inventory from a plurality of Marketplaces 500 by standardizing the input fields within each one of the marketplaces and synchronizing them to meet particular requirements (e.g., field name, type, inventory classification, geographic considerations) of a network-based trading platform on which the Post-Sales Management Module 120 is located (e.g., the Synchronization Module 502 might receive only a subset of all the inventory on Marketplaces 500 and align the inventory to meet the format and parameter requirements set within Post-Sales Management Module 120 such as stock keeping unit, country of origin, etc.).

The Synchronization Module 502 may align inventory levels from one or more Marketplaces 500 by using a time-phased logic algorithm in one embodiment. This time-phased logic algorithm determines what time a particular inventory has been uploaded into a particular marketplace. Each inventory level within Marketplaces 500 may conform to a uniform time-stamp system according to one embodiment. This uniform time-stamp may be placed on each and every item of inventory that is uploaded into a particular marketplace.

By placing a time-stamp on every item of inventory, the Synchronization Module 502 is able to determine whether the Inventory Module 504 includes the current inventory level and how the inventory replenishment and sell through has been on each marketplace in one embodiment. (e.g., the Synchronization Module 502 might compare the time-stamp and location on each item of inventory stored in Inventory Module 504 with the incoming time-stamp on new items of inventory from Marketplaces 500, and calculate alerts based on the inventory aging or lead time). In one embodiment, future inventory (e.g., scheduled receipts or purchase orders) that may arrive at a Marketplace 500 may be aligned through the Synchronization Module 502 (e.g., may be queued to be uploaded into Inventory Module 504 when the inventory arrives at Marketplace 500).

By tracking the time inventory was uploaded into Marketplaces 500, the Synchronization Module 502 can determine inventory sell through and forecasting within the Post-Sales Management Module 120. This may allow a seller to schedule further listings by understanding how his sell through and replenishment may occur across Marketplaces 500 (e.g., a seller might know to list a particular item on a network-based trading platform because new inventory is scheduled to arrive, or drop the price of inventory that has been in stock for a long time).

Synchronization Module 502 communicates with Inventory Module 504 as illustrated in FIG. 5. Information about current inventory levels at one or more Marketplaces 500 is communicated and synchronized before it is updated and sent to Inventory Module 504, in one embodiment. When Inventory Module 504 receives the synchronized inventory from Synchronization Module 502, it automatically updates its inventory table (the inventory table might be stored within a single database) to provide a global view of on hand and/or expected inventory across one or more Marketplaces 500 to a particular seller in one embodiment.

The Accounting Module 506 communicates with the Order Table 98 and receives information about orders that have been recently sold to buyers (e.g., these orders may be over a network-based auction environment or a fixed price sell environment). The Accounting Module 506 communicates with the Inventory Module 504 and transmits information regarding final value fee calculation and non-paying bidder information in one embodiment as will later be discussed in FIG. 6. The Inventory Module 504 and the Accounting Module 506 work in conjunction with each other to provide the current status and alert updates to Alert and Notify Module 508. Alert and Notify Module 508 pulls information regarding current inventory from Inventory Module 504 and payment status from Accounting Module 506 and consolidates them into meaningful alerts for a particular buyer or seller, according to one embodiment.

The Alert and Notify Module 508 also may communicate alerts to User Interface Module 510 through Alerts Bus 514. In one embodiment, the Alert and Notify Module 508 may automatically to generate one or more alerts when at least one post-sales parameter (e.g., inventory out of stock, forecasted inventory low, etc.) transgresses a threshold. In one embodiment, threshold levels can be set by a user of a network-based trading platform through the User Interface Module 510.

The User Interface Module 510 may in one embodiment receive inputs from a particular seller or buyer that trigger a change in inventory levels within Inventory Module 504 (e.g., through an Internet-based user interface or through a client-based application that uploads information to a network-based trading platform a user may manually update time-stamp indicators). Inputs may include listing title, starting price, payment options, shipping options, and payment options for a particular item of inventory according to one embodiment.

These inputs may then be sent back to the Inventory Module 504 through Inventory Adjust Bus 512 and updated by Inventory Module 504. Similarly, the Inventory Module 504 may periodically request input (e.g., parameter requests for synchronization, manual corrections to synchronized inventory levels from marketplaces 500) from a user accessing the Inventory Module 504 through User Interface Module 510. These changes may be responded to by a user through User Interface Module 510, and communicated back to Inventory Module 504 for updating.

FIG. 6 is a relational view between the Synchronization Module 502, the Inventory Module 504, and the Accounting Module 506 inside the Post-Sales Management Module 120 (as shown in FIG. 5), according to one embodiment.

The Synchronization Module 502 communicates with the Inventory Module 504 as illustrated previously in FIG. 5. However, FIG. 6 is an exploded view of the Synchronization Module 502 and the Inventory Module 504. Furthermore Accounting Module 506 is also shown as communicating with Inventory Module 504. One or more private Marketplaces 600A-600N transmit aggregated data of current inventory to Aggregator 602 within Synchronization Module 502. These marketplaces may be private Internet-based marketplaces, or physical store locations at a particular seller. A number of public Marketplaces 650A-650N are also connected to Synchronization Module 502 through the Internet 603.

Aggregator 602 within Synchronization Module 502 has the task of consolidating inventory from both the local Marketplaces 600A-600N and network-based Marketplaces 650A-650N. The Aggregator 602 provides a multiplex signal that includes an aggregated view of inventory positions at a variety of marketplaces to a Demux 604. The Demux 604 breaks down the aggregated inventory blocks received from Aggregator 602 into individualized product names that may include a particular product aggregated across a plurality of Marketplaces 600A-600N and 650A-650N. As such, the Comparator Logic 606 receives individual products of inventory, whereas the Aggregator 602 had previously received tables of inventory that had to be recompiled into a single multiplex signal before sending to Demux 604.

The Comparator Logic 606 compares the individualized products received from Demux 604 to an Inventory Table 112 within the Inventory Module 504 through Compare bus 612. In one embodiment, the Comparator Logic 606 compares the current state inventory to individual products by applying a time phasing logic as previously discussed in FIG. 5.

In order to keep track of the relational time updates (as described with reference to FIG. 5) of inventory received through Demux 604 and Inventory Table 112, a State Machine 608 is used to synchronize the logic functions required to provide a time-phased view of inventory in one embodiment.

A Buffer 609 may temporarily store inventory that is currently being computed by a State Machine 608 so that time-phased inventory received from Aggregator 602 is aligned with the current Inventory Table 112. As such, in a time-phased embodiment, inventory that had previously been calculated in calculating the total inventory in Inventory Table 112 has a time stamp so that new inventory received from the Demux 604 that is older than the time stamp on Inventory Table 112 for each item of inventory under 112 is compared by Comparator Logic 606. If the time stamp for a particular inventory within Inventory Table 112 is earlier than the new input received from Demux 604, then the Comparator Logic 606 updates the inventory state accordingly (e.g., inventory is categorized by when it is received). If the Inventory Table 112 contains a particular inventory that has the same time of update as what is received from Demux 604, the Comparator Logic 606 does not update the inventory.

The updated inventory is passed Status Updater 610. The Status Updater 610 reconfigures what changes need to be made to the Inventory Table 112 and passes those changes to Inventory Table 112 through Update 614. The Inventory Module 504 communicates with the Accounting Module 506 by transmitting information about current state inventory. The Accounting Module 506 receives current orders from particular buyers through Order Table 112 as illustrated in FIG. 5 and transmits decrement instructions to Inventory Module 504 through Bus 616.

The Accounting Module 506 includes a number of sub modules, including a Final Value Fee Module 616, a Payment Tracking Module 617, and a Non Paying Bidder Module 618. These sub modules determine various calculations for accounting and maintenance of a synchronized inventory view for a particular seller.

The Final Value Fee Module 616 calculates the current amount owed by a particular seller to a network-based trading exchange based upon the orders that have recently been received and have not been paid by the seller. The Final Value Fee Module 616 may include a Final Value Fee Table 114 as previous described in FIG. 3. The Non Paying Bidder Module 618 keeps track of which particular bidders have not yet paid for particular items that have been transacted over a network-based trading platform. The Non Paying Bidder Module may include a non-paying bidder table 116 as previous described in FIG. 3.

Both the Inventory Module 504 and the Accounting Module 506 communicate to Alert and Notify Module 508 by sending out data that is required for computation by the Alert and Notify Module 508. Information about signals that need to be relayed to buyers and sellers transacting on a network-based trading platform is also communicated from Inventory Module 504 and Accounting Module 506 to the Alert and Notify Module 508.

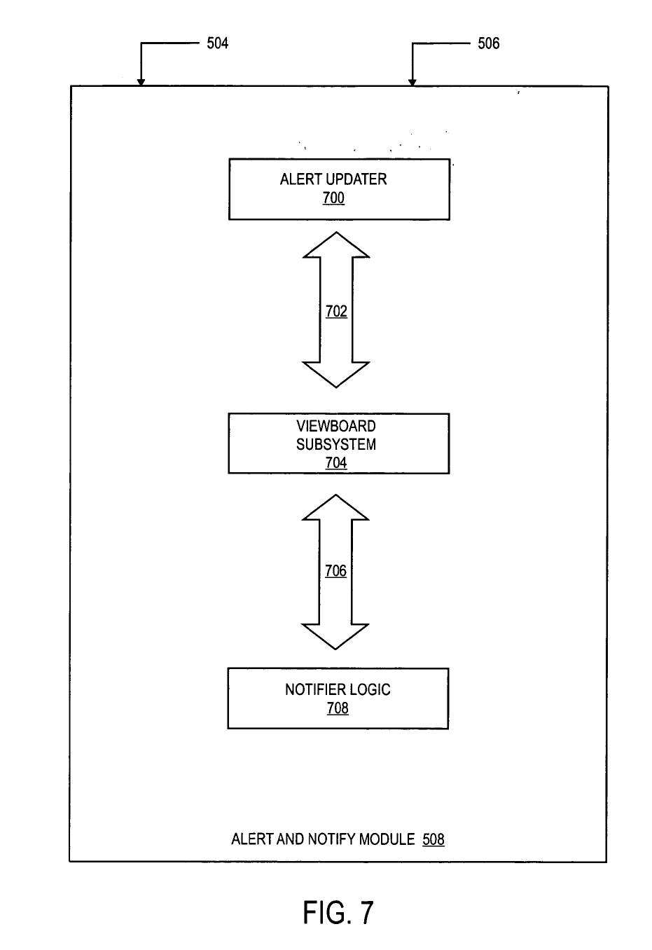

FIG. 7 is an exploded view of the Alert and Notify Module 508 within the Post-Sales Management Module 120 (as illustrated in FIG. 5), according to one exemplary embodiment. In FIG. 7 an Alert Updater 700 is connected to a Viewboard Subsystem 704 through Bus 702. The Alert Updater 700 receives updated alert signals from the Inventory Module 504 and the Accounting Module 506. The Alert Updater 700 prepares a replenish alert when inventory level drops below a particular threshold (e.g., inventory level drops below a minimum stock-keeping range). In another embodiment, the replenish alert is generated when forecasted inventory requirements do not meet expected demand. In another embodiment, the Alert Updater 700 automatically generates a ship alert when an item of the inventory of sold items has not been shipped (e.g., the Alert Updater 700 may directly communicate a ship alert to a common carrier for example). The Alert Updater 700 may also communicate with a common carrier tracking system to communicate shipment status automatically through the alert and Notify Module 508 in one embodiment. The Alert Updater 700 may also automatically generate a payment due alert when payment has not been received for an item of the inventory of sold items within a predetermined time period by receiving updated payment status from the Accounting Module 506.

The Viewboard Subsystem 704 prepares the alerts for display to a user either through an online web based dashboard or through another direct communication medium (e.g. email). The Viewboard Subsystem 704 connects to the Notifier Logic 708 through Bus 706. The Viewboard Subsystem 704 may generate reports based on the categories, and provide these reports to the sellers through a dashboard view customizable for different service levels offered to the sellers (e.g., a seller may have access to only some reports that can be generated by the Viewboard Subsystem 704).

The Notifier Logic 708 prepares and automatically sends out the actual alerts to various buyers and sellers depending upon which alerts have been created by the Alert Updater 700 and Viewboard Subsystem 704. In another embodiment, the Notifier Logic 708 informs a buyer or seller that an alert is pending within the Post-Sales Management Module 120 (as shown in FIG. 5). The Notifier Logic 708 may also consolidate information from the Viewboard Subsytem 704 into reports, which include an average selling price report and an average time to sell report for the plurality of sellers. The Notifier Logic 708 may also generate metrics such as profit, loss, revenue, and on-hand inventory to be communicated to the Viewboard Subsystem 704.

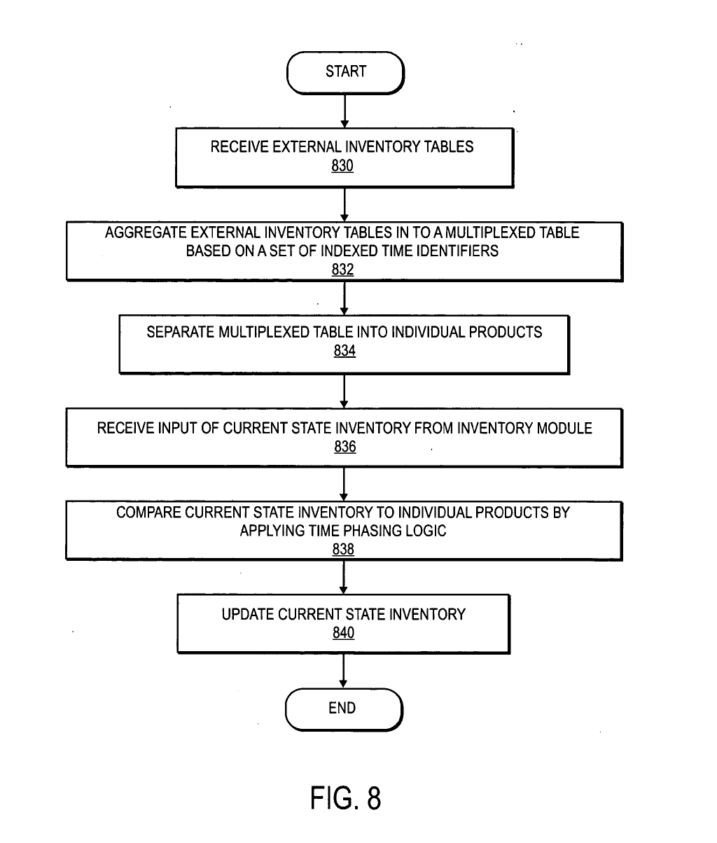

FIG. 8 is a process flow of operations within the Synchronization Module 502 according to one embodiment. In Operation 830, external (and/or internal) inventory tables are received by the Synchronization Module 502. In Operation 832, external inventory tables are aggregated into a multiplexed table based on a set of indexed time identifiers (e.g., as previously described with reference to FIG. 5 and to the Aggregator 602 and Demux 604 in FIG. 6). In one embodiment, Aggregator 602 aggregates inventory from one or more marketplaces based on indexed time identifiers within each item of inventory received from external inventory tables.

In another embodiment, internal inventory tables local to the network-based trading system are transferred through Aggregator 602 in addition to external inventory tables. Next in Operation 834, the multiplexed table is separated into individual products. In Operation 836, current state inventory is received from the Inventory Module (e.g. the Inventory Module 504 in FIG. 6). In Operation 838, current state inventory is compared to individual products by applying time phasing logic as previously described in FIG. 5 and FIG. 6. In Operation 840, current state inventory is updated. The inventory may be updated within a single database within a network based trading system according to one embodiment.

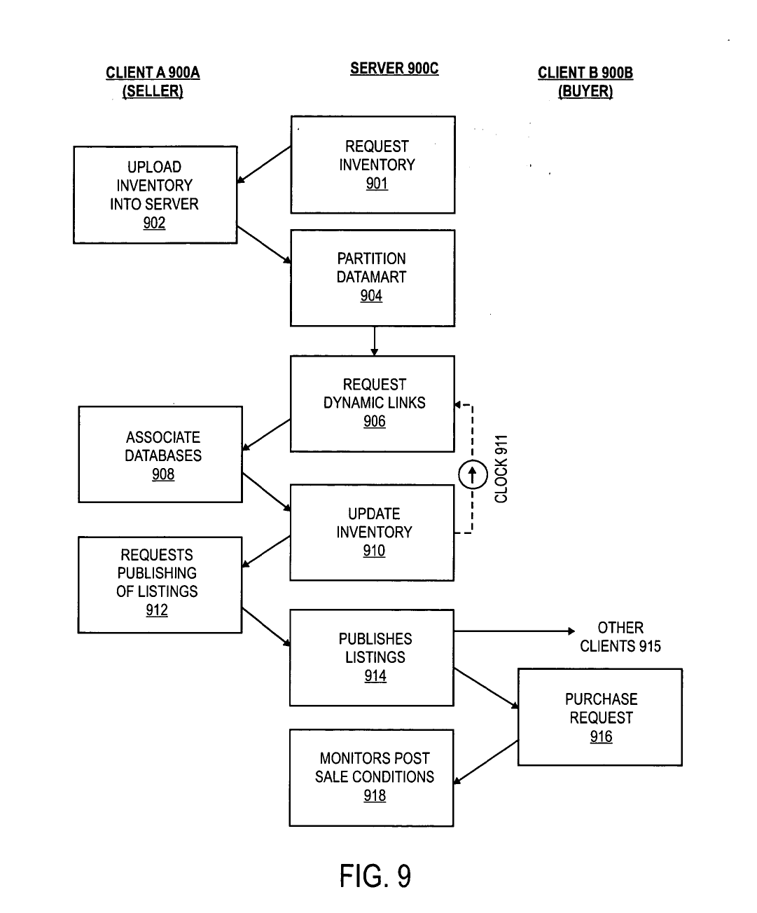

FIG. 9 is a seller client server and buyer client interaction diagram showing communication between the server and clients according to one embodiment. In Operation 901, inventory is requested by a Server 900C. In Operation 902, a Client A 900A uploads inventory into the server after Request Inventory 901 is received. Client A 900A may be a seller according to one embodiment. In Operation 904, the Server 900C receives the inventory that has been sent from the Client A 900A and partitions the data mark within the Server 900C. Next, Server 900C requests dynamic links in Operation 906 from the Client A 900A. Then, Client A 900A associates the databases in Operation 908 (e.g., the seller might associate databases that incorporate a time-stamp logic or may select particular private and/or public marketplaces from which to link inventory information to the Post-Sales Management Module 120). The inventory is updated in Operation 910 at the Server 900C (e.g., the Inventory Module 504 as previously described in FIG. 5 and FIG. 6 may be updated). A Clock 911 pulses on a periodic basis back to Request Dynamic Links 906 in order to get updated inventory levels on each pulse count. The Clock 911 may include a timer that can be set by a seller or a network-based trading platform in one embodiment. In Operation 912, publishing of listings is requested. In Operation 914, the listings are published (e.g., the products within the listings may be made available to buyers over one or more marketplaces). The listings may be published to a group of buyer clients as illustrated with Other Clients 915. One particular client illustrated as Client B 900B may be a buyer who initiates a purchase request in Operation 916. This purchase request may then be generated into an invoice so that Server 900C can monitor post-sale conditions in Operation 918.

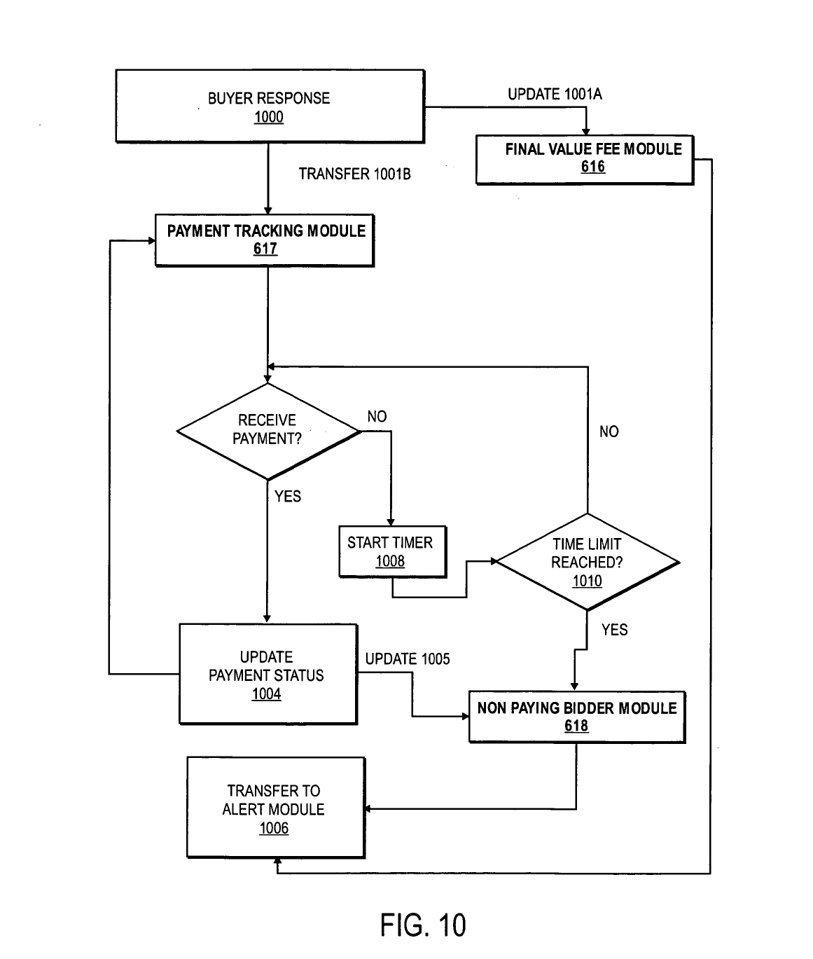

FIG. 10 is a process flow for operations within the Accounting Module 506 according to one embodiment. In FIG. 10, a Buyer Response 1000 is received. The Buyer Response 1000 may be an order for a new product that the seller has listed, or it may be a change to an existing order. Once a Buyer Response 1000 is received, it is transferred to the Payment Tracking Module 617 through the Bus 1001B and to the Final Value Fee Module 616 through Bus 1001A. Both the Final Value Fee Module 616 and the Payment Module 617 may be located within the Accounting Module 506 in one embodiment as shown in FIG. 6. The Final Value Fee Module 616 calculates the amount owed to the network-based trading platform for that particular transaction by the seller. In one embodiment, the amount owed might be based upon a percentage of revenue received from a particular order. Payment Module 617 then checks to see if the payment has been received for a particular order. If the payment is received, the payment status is updated in Operation 1004. If the payment is not received, the Timer 1008 is started.

If the time limit is reached in Decision Point 1010, the buyer information is passed to Non Paying Bidder Module 618. If the time limit is not reached, then whether the payment is received is again evaluated. If the payment is received, the Update Payment Status 1004 updates the Payment Module 617 and updates Non Paying Bidder Module 618 if it includes information about a particular non-paying buyer. The Non Paying Bidder Module 618 then communicates with the Alert Module in Operation 1006 and the alerts are transmitted to the Alert Module 1006. Similarly, the Final Value Fee Module 616 transfers information about fees owed to the network-based trading platform to the Alert Module in Operation 1006.

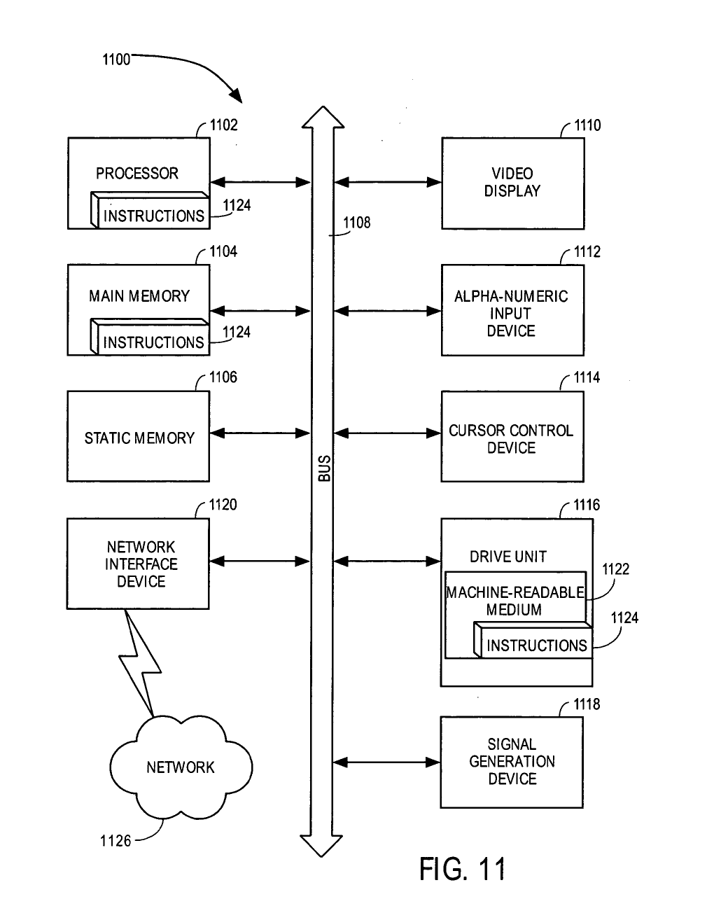

FIG. 11 shows a diagrammatic representation of machine in the exemplary form of a Computer System 1100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The Exemplary Computer System 1100 includes a Processor 1102 (e.g., a central processing unit (CPU) a graphics processing unit (GPU) or both), a Main Memory 1104 and a Static Memory 1106, which communicate with each other via a Bus 1108. The Computer System 1100 may further include a Video Display Unit 1110 (e.g., a liquid crystal display (LCD) or a cathode ray tube (CRT)). The Computer System 1100 also includes an Alphanumeric Input Device 1112 (e.g., a keyboard), a Cursor Control Device 1114 (e.g., a mouse), a Disk Drive Unit 1116, a Signal Generation Device 1118 (e.g., a speaker) and a Network Interface Device 1120.

The Disk Drive Unit 1116 includes a Machine-Readable Medium 1122 on which is stored one or more sets of instructions (e.g., Software 1124) embodying any one or more of the methodologies or functions described herein. The Software 1124 may also reside, completely or at least partially, within the Main Memory 1104 and/or within the Processor 1102 during execution thereof by the Computer System 1100, the Main Memory 1104 and the Processor 1102 also constituting machine-readable media.

The Software 1124 may further be transmitted or received over a Network 1126 via the Network Interface Device 1120.

While the Machine-Readable Medium 1122 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

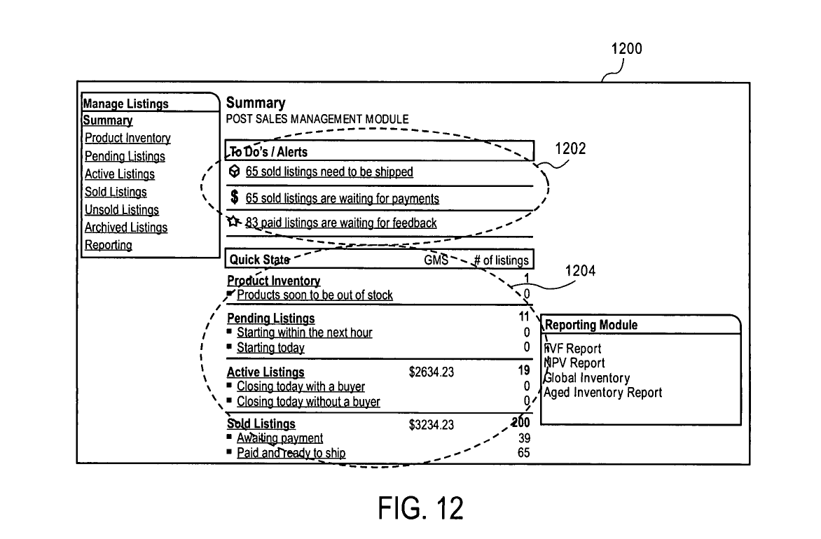

FIG. 12 illustrates a screen shot a Summary View 1200 of a particular embodiment utilizing the Post-Sales Management Module 120. In FIG. 12 a “To Do's” Alerts 1202 and the “Quick Stats” 1204 provide notification of the logic that has been previously been described with reference to FIGS. 1-11. In one embodiment, the “Quickstats” 1204 and the “To Do's” Alerts 1202 are generated by Alert and Notify Module 500 through Notifier Logic 700.

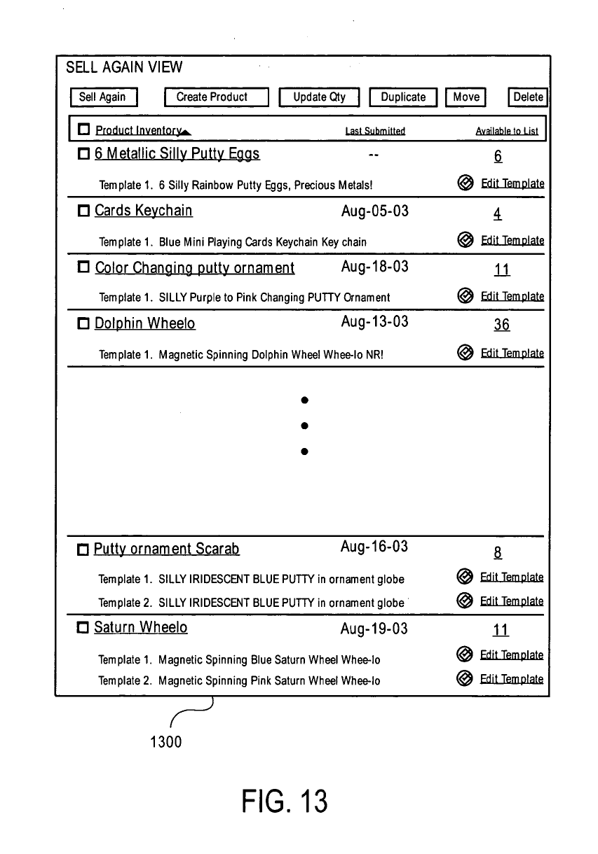

FIG. 13 is a screen shot showing a Sell Again View 1300 showing how a seller can utilize the post-sale conditions within the Post-Sales Management Module 120 and the pre-sales management logic to re-list items onto a network-based trading platform for sale. A pre-sales management logic (not shown) may be used as described in FIG. 2, that has a set of one or more templates (e.g., reusable pre-arrangements of data that can be applied to future listings). These templates may be created by a seller from scratch, or may be created from existing listings. In one embodiment, templates may include all information included in a preexisting listing. In another embodiment, information in a first listing may be selected by a user and reused for future listings (e.g., a user may not have to elect to use all portions of a listing to include within a template).

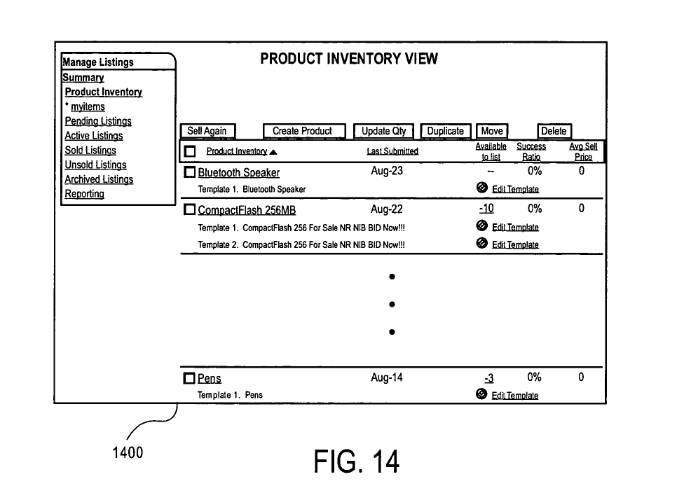

FIG. 14 is a screen shot showing a Product Inventory View 1400 according to one embodiment. In one embodiment, the Product Inventory View 1400 shown in FIG. 14 is stored within an Inventory Module 504 and updated using the Synchronization Module 502 as previously described with reference to FIG. 5 and in FIG. 6.

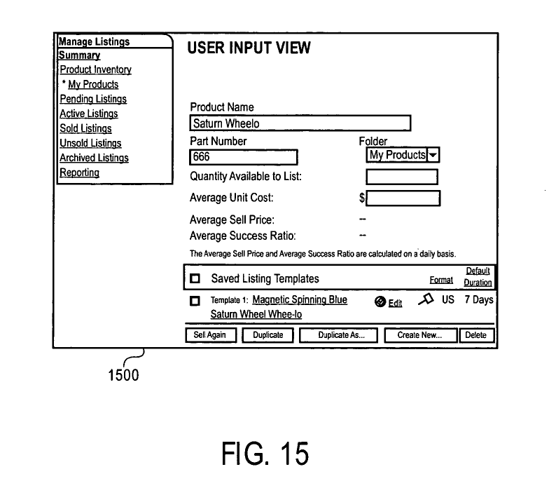

FIG. 15 is a screen shot showing the User Input View 1500 for the User Interface Module 510 according to one embodiment. Specifically, FIG. 15 illustrates how inventories are manually edited and/or uploaded by a seller into the Inventory Module 504.

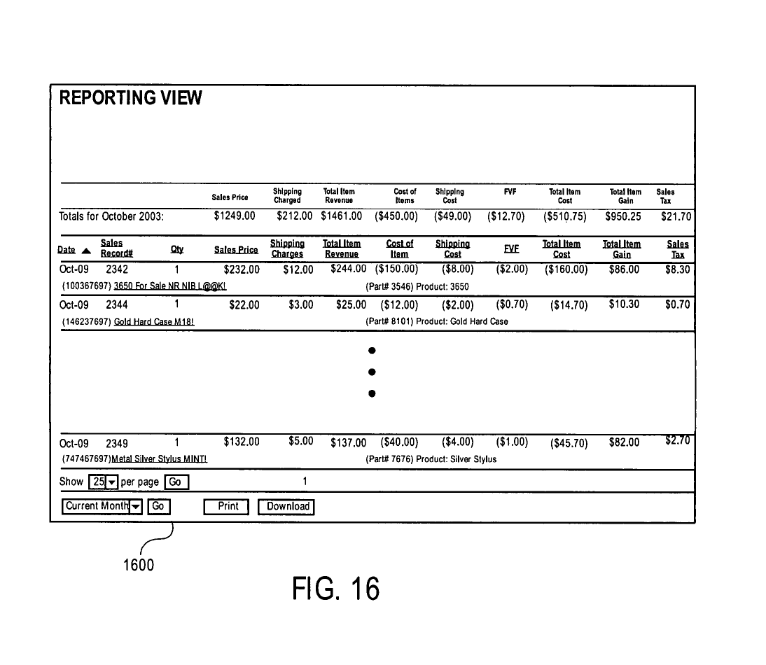

FIG. 16 is a screen shot showing the Reporting View 1600 an exemplary embodiment in which calculations and reports are provided for a seller based upon inventory located across one or more trading platforms.

A method and system to measure and monitor post-sales conditions within a network-based trading platform have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system for managing post-sales parameters within a network-based trading environment, the system including:
a post-sales management module automatically to monitor post-sales parameters pertaining to an inventory of sold items; and
an alert module automatically to generate an alert when at least one post-sales parameter transgresses a threshold.
